(19) United States
(12) Patent Application Publication
(10) Pub. No.: US 2011/0278101 A1
(43) Pub. Date: Nov. 17, 2011

(54) ELEVATOR SYSTEM

(75) Inventor: Wei Wu, Tokyo (JP)

(73) Assignee: MITSUBISHI ELECTRIC CORPORATION, Tokyo (JP)

(21) Appl. No.: 13/146,406

(22) PCT Filed: Feb. 18, 2009
(86) PCT No.: PCT/JP2009/052775

§ 371 Date: Jul. 27, 2011

(51) Int. Cl. B66B 1/18

(52) U.S. Cl. 187/382

(57) ABSTRACT

In an elevator system in which a plurality of elevators are operated based on a destination floor registered from a destination floor registration device in an elevator hall, the optimal operation of elevator can be realized, and a user boarding the elevator car from the hall can surely confirm his/her registered destination floor. For this purpose, a destination floor indication device is installed in the elevator car, and the destination floor of the car is indicated on the destination floor indication device. Also, when a user boards the car from a hall, only the destination floor registered from that hall is indicated on the destination floor indication device.

### TECHNICAL FIELD

The present invention relates to an elevator system in which a plurality of elevators are controlled properly based on a call from a destination floor registration device provided in an elevator hall.

### BACKGROUND ART

FIG. 4 is a front view showing one example of a car operating panel for an elevator. On the car operating panel shown in FIG. 4, car call buttons 13 for elevator destination floors are provided, and a numeral or the like is marked on the surface of each car call button 13 to indicate the floor name. When a user uses an elevator provided with a car operating panel configured as described above, after boarding a car, the user presses a car call button 13 to register his/her desired destination floor. When the destination floor is registered by the above-described operation, an LED or the like installed in the car call button 13 is lighted to inform the user that the destination floor has already been registered.

On the other hand, if the number of service floors (destination floors) of the elevator increases as in a high rise building, on the car operating panel having the configuration shown in FIG. 4, a large number of car call buttons must be arranged, which poses various problems such as an increase in installation space.

To solve this problem, for example, Patent Document 1 has proposed an elevator system in which a ten-key type destination floor registration device is installed in a car or the like. This ten-key type destination floor registration device cannot indicate the destination floor having been registered for the user. In the case where the ten-key type device is adopted as the destination floor registration device, in addition to the destination floor registration device, a destination floor indication device for indicating the registered destination floor must be installed in the car or the like.

Patent Document 1 discloses a destination floor indication device in which an LED is lighted and extinguished for each destination floor. For this destination floor indication device, unfortunately, a large number of indicators must be arranged if the number of service floors of the elevator increases. Therefore, the same problem as the above-described problem, such as an increase in installation space and installation cost, arises.

On the other hand, as another prior art, an elevator system has been proposed in which a destination floor indication device consisting of a liquid crystal display is installed in a hall, a car, and the like of the elevator, and the display content is changed according to the content of the registered destination floor (for example, refer to Patent Document 2). According to the destination floor indication device configured as described above, the problem such as an increase in installation space and installation cost can be solved by performing proper control such that only the registered destination floor is indicated.
Patent Document 1: Japanese Patent Laid-Open No. 8-175770
Patent Document 2: International Publication No. WO2005/105643

### DISCLOSURE OF THE INVENTION

### Problems to be Solved by the Invention

On the other hand, as an elevator system, there is available a system in which the destination floor registration device is installed in an elevator hall, and based on the destination floor registered from this destination floor registration device, a plurality of elevators are operated optimally (a destination oriented allocation system (DOAS)). In the case where this destination oriented allocation system is adopted, there arises a problem that the optimal operation of elevators cannot be realized if the destination floor indication device described in Patent Document 2 is installed in a hall.

That is to say, in order to perform the optimal operation of elevators in the destination oriented allocation system, the allocation of elevator cars must be planned strategically by exactly figuring out the number of users for each destination floor. For this purpose, in the destination oriented allocation system, it is desirable to get all the users to register their destination floors from the destination floor registration device. However, if the destination floor indication device described in Patent Document 2 is installed in a hall, some users board the elevator car without registering their destination floors. This is because the user who can confirm, from the indication content of the destination floor indication device, that his/her destination floor has already been registered does not take the trouble to reregister his/her destination floor.

In view of such circumstances, for the elevator adopting the destination oriented allocation system, the destination floor indication device is not installed in the hall in some case. In such a case, the user must confirm that he/she has boarded a proper elevator car by looking at the destination floor indication device installed in a car when or after boarding the elevator car.

However, for example, in the case where the destination floor indication device described in Patent Document 1 or 2 is installed in a car, there arises a problem that the user must look for his/her registered destination floor from indicators arranged in large numbers or from an indication screen on which many destination floors are indicated. In particular, in the case where the elevator has many service floors, much time is required for the user to look for his/her registered destination floor, so that the elevator car may start running before the user can confirm that he/she has boarded the proper elevator car.

Also, for the destination floor indication device described in Patent Document 2, since the space for indicating the destination floors is limited, all of the destination floors of elevator sometimes cannot be indicated. In this case, the destination floor registered newly from a hall cannot be indicated, so that the user boarding the elevator car may be unable to confirm his/her destination floor in the car.

The present invention has been made to solve the above problems, and an object of the present invention is to provide an elevator system in which a plurality of elevators are operated based on the destination floor registered from a destination floor registration device in an elevator hall, the elevator system being configured so that the optimal operation of elevators can be realized, and the user boarding an elevator car from the hall can surely confirm his/her registered destination floor.

### Means for Solving the Problems

An elevator system of the present invention is an elevator system that comprises a destination floor registration device which is provided in an elevator hall so that a user registers a destination floor before boarding an elevator car, a group controller for performing group control of a plurality of elevators based on the destination floor registered from the destination floor registration device, a destination floor indication device provided in the car of the elevator to indicate the destination floor of the car, and destination floor indication control means which causes the destination floor indication device to indicate only the destination floor registered from the hall when a user boards the car from the hall.

### Effect of the Invention

According to the present invention, in the elevator system in which a plurality of elevators are operated based on the destination floor registered from the destination floor registration device in an elevator hall, the optimal operation of elevators can be realized, and the user boarding an elevator car from the hall can surely confirm his/her registered destination floor.

### BRIEF DESCRIPTION OF THE DRAWINGS

FIG. 1 is a block diagram showing the general configuration of an elevator system in a first embodiment according to the present invention.

FIG. 2 is a flowchart showing the operation of the elevator system in the first embodiment according to the present invention.

FIG. 3 is a block diagram showing the configuration of the essential portion of the elevator system in a second embodiment according to the present invention.

FIG. 4 is a front view showing one example of a car operating panel for an elevator.

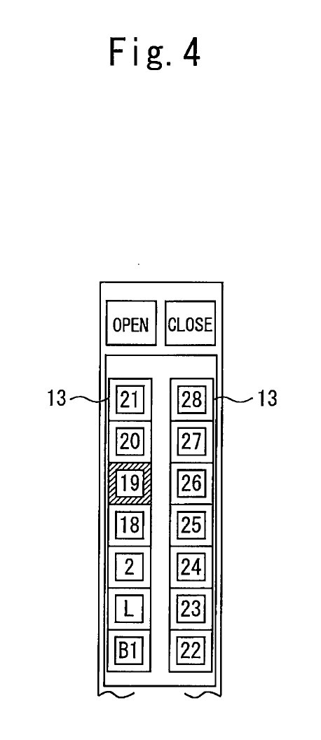

### DESCRIPTION OF SYMBOLS

1 destination floor registration device,
2 group controller,
3 controller,
4 destination floor indication device,
5 indication section,
6 indication control section,
7 data storage section,
8 communication section,
9 memory,
10 microcomputer,
11 sound generating section,
12 sound control section,
13 car call button

### BEST MODE FOR CARRYING OUT THE INVENTION

The present invention will be described in more detail with reference to the accompanying drawings. Incidentally, in each of the drawings, like numerals refer to like or similar parts and redundant descriptions of these parts are appropriately simplified or omitted.

### First Embodiment

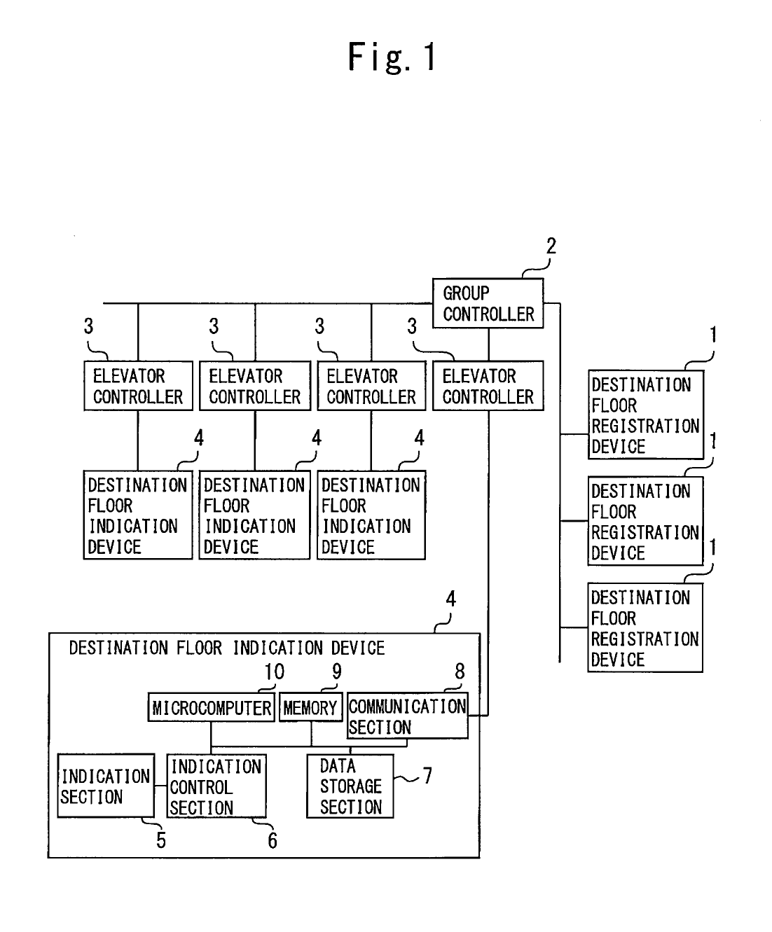

FIG. 1 is a block diagram showing the general configuration of an elevator system in a first embodiment according to the present invention. The elevator system of this embodiment is one example of the elevator systems adopting the destination oriented allocation system (DOAS).

In FIG. 1, reference numeral 1 denotes a destination floor registration device for the user to register his/her destination floor before boarding (the car of) an elevator. The destination floor registration device 1 is installed in one or a plurality of elevator halls. The destination floor registration device 1 may be installed in plural numbers in one hall. When an elevator user performs a predetermined operation on the destination floor registration device 1 to register his/her destination floor, the destination floor registration device 1 sends the registration information (that is, a hall call and a destination call) to a group controller 2.

The group controller 2 has a function for performing group control of a plurality of elevators installed in the identical building or the like. That is, the group controller 2 is provided with a function of the destination oriented allocation system (DOAS).

Specifically, when receiving the registration information from the destination floor registration device 1, the group controller 2 assigns the optimal elevator from the plurality of elevators to the received registration information. After performing the assignment to the registration information, the group controller 2 sends the assignment information to the destination floor registration device 1 that sent the registration information, and causes the destination floor registration device 1 to be informed of the assignment result. That is, the user registers his/her destination floor, and thereafter recognizes the elevator car that the user boards by looking at the assignment result indicated on the destination floor registration device 1.

Also, after performing the assignment to the registration information, the group controller 2 sends an operation command based on the registration information to the controller 3 of the assigned elevator.

Specifically, after performing the assignment to the registration information, the group controller 2 first makes hall call registration on the relevant controller 3. The controller 3 on which the hall call has been registered runs the elevator car to the hall from which the registration information is inputted. Also, the controller 3 lands the car at the hall, and thereafter performs door opening and closing operations successively. That is, the controller 3 performs operations for the user who inputted the registration information to cause to board the elevator car.

When the elevator car arrives at the hall in response to the hall call, the group controller 2 next makes destination call registration on the controller 3 of the elevator. The controller 3 on which the destination call has been registered completes the door closing operation in the hall, and thereafter runs the elevator car to the destination floor. The controller 3 lands the car at the destination floor, and thereafter performs door opening and closing operations successively. That is, the controller 3 performs operations for the user who boarded from the hall to cause to alight from the car at the destination floor.

Reference numeral 4 denotes a destination floor indication device provided in the car of each elevator. The destination floor indication device 4 indicates the destination floor for the user in the car, and the indication content thereof is controlled by destination floor indication control means. The destination floor indication control means is provided in the destination floor indication device 4 having an indication section 5, the controller 3, and the like. An independent device provided with the destination floor indication control means may be provided separately. In this embodiment, a case where the essential portion of the destination floor indication control means is provided in the destination floor indication device 4 is shown.

Specifically, the essential portion of the destination floor indication device 4 is configured by the indication section 5, an indication control section 6, a data storage section 7, a communication section 8, a memory 9, and a microcomputer 10.

The indication section 5 has a function of indicating a destination floor. Specifically, the indication section 5 consists of an indicator that indicates letters, figures, and the like, and is configured, for example, by a liquid crystal display, a plasma display, an LED display, a cathode-ray tube display, or the like. The indication control section 6 has a function of controlling the processing of the indication section 5.

The data storage section 7 stores various data necessary for destination floor indication. Specifically, the data storage section 7 stores not only the indication content data itself of destination floor but also data such as a correspondence table between the indication command of destination floor, described later, and the indication content, and the upper limit value of the number of destination floors capable of being indicated simultaneously on the indication section 5.

The communication section 8 has a function of communicating with the controller 3. That is, the destination floor indication device 4 sends and receives various pieces of information to and from the controller 3 via this communication section 8. Specifically, the communication section 8 acquires various pieces of information, such as the indication command of destination floor, the number of registered destination floor, and the operation condition of elevator, from the controller 3. The communication section 8 may adopt any communicating method, wire or wireless, as far as information can be transmitted.

The memory 9 is configured, for example, by a program memory for program and a work memory for work. The microcomputer 10 controls the processing of the sections 5 to 8 provided in the destination floor indication device 4 by using the memory 9.

Incidentally, the data storage section 7 and the program memory may be configured by any storage device or storage element such as a hard disc drive, a nonvolatile memory, or a dynamic random access memory. Also, all or some of the indication control section 6, the data storage section 7, the communication section 8, and the memory 9 may be incorporated in the microcomputer 10. In the case where the communication section 8 is omitted, as the data storage section 7, a nonvolatile storage capable of being attached to and detached from the destination floor indication device 4 can be used.

The destination floor indication device 4 having the above-described configuration performs indication control of destination floor by using the sections 5 to 10 based on the indication command sent from the controller 3.

Incidentally, the indication command is a command given from the controller 3 to the destination floor indication device 4 according to the operation condition of elevator to perform the indication of destination floor. Specifically, when destination call registration is made by the group controller 2, the controller 3 makes indication registration of the destination floor concerned together with the above-described elevator operation control. During the time when the indication registration is being made, the controller 3 sends the indication command of the destination floor to the destination floor indication device 4. Also, when the car is landed at the destination floor in response to the destination call, the controller 3 generates a command for canceling the indication of the destination floor. That is, by this command, the above-described indication registration is canceled, and the transmission of the indication command to the destination floor indication device 4 is stopped.

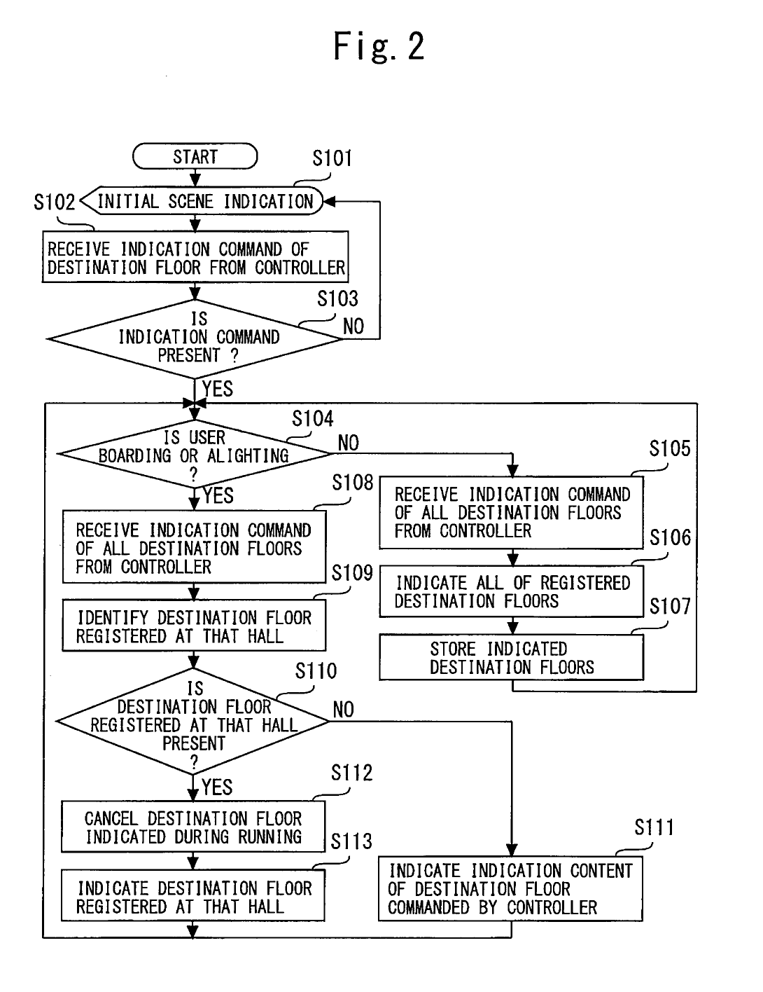

Next, the specific operation of the destination floor indication device 4 having the above-described configuration, that is, the specific function of the destination floor indication control means is explained with reference to FIG. 2. FIG. 2 is a flowchart showing the operation of the elevator system in the first embodiment according to the present invention.

The destination floor indication device 4 indicates an initial scene such as a background scene on the indication section 5 (S101), and receives the indication command of destination floor from the controller 3 and confirms the presence of indication command (S102, S103). In S103, if the indication command is absent, the destination floor indication device 4 continues the initial scene indication, and repeats the above-described operation until the receipt of indication command is confirmed.

When confirming the receipt of indication command in S103, the destination floor indication device 4 first confirms the operation condition of elevator, and judges whether or not the user is boarding the elevator car or alighting from the elevator car (S104). Specifically, the destination floor indication device 4 acquires the operation information of elevator from the controller 3 via the communication section 8, and makes the above-described judgment. Herein, “time during the user is boarding the elevator car or alighting from the elevator car” means, for example, time from when the elevator makes a decision to arrive at a certain floor to when the elevator car begins to run from the certain floor toward another floor. That is, the time during the elevator car is stopping is included in the time during the user is boarding the elevator car or alighting from the elevator car. Also, during the time from when the elevator car begins to run toward a certain floor to when the elevator makes a decision to arrive at another floor, in S104, it is judged that the user is not boarding the elevator car and alighting from the elevator car (that is, the elevator car is running).

If it is judged, in S104, that the elevator car is running, the destination floor indication device 4 receives the indication command of all destination floors from the controller 3 via the communication section 8 (S105), and indicates all of the received destination floors on the indication section 5 (S106). Also, to store the destination floors indicated on the indication section 5 in S106, the destination floor indication device 4 retains the information on the indicated destination floors in an indication content database of the data storage section 7 (S107).

On the other hand, if it is judged, in S104, that the user is boarding the elevator car or alighting from the elevator car, the destination floor indication device 4 first receives the indication command of all destination floors from the controller 3 via the communication section 8 (S108). Next, the destination floor indication device 4 identifies an indication command corresponding to the destination floor registered from the hall at which the user is boarding the elevator car or alighting from the elevator car at present (the car is stopping) from among the indication commands received in S108, and judges whether or not the destination floor registered at that hall is present (S109, S110).

Incidentally, in S109, the destination floor indication device 4 identifies the destination floor registered at that hall based on, for example, a difference between the indication command received in S108 and the indication command received in S105 during running just before the boarding. That is, the destination floor indication device 4 accomplishes the identification by preparing a destination floor list about all the indication commands received in S108 and by comparing the destination floor list with the destination floor information retained in S107.

If it is judged, in S110, that the destination floor registered at that hall is not present, the destination floor indication device 4 indicates the indication content of the destination floor, which is commanded by the controller 3, on the indication section 5, and returns to S104 (S111). At this time, in the case where the destination floor to be indicated is absent, the destination floor indication device 4 returns to S101 and indicates the initial scene. On the other hand, if it is judged, in S110, that the destination floor is present, the destination floor indication device 4 cancels the destination floor indicated on the indication section 5 during running, and indicates only the destination floor registered at that hall on the indication section 5 (S112, S113).

According to the first embodiment of the present invention, in the elevator system provided with the destination floor registration device 1 and the group controller 2, the user boarding the elevator car from a hall can surely confirm his/her registered destination floor. Also, a device corresponding to the destination floor indication device 4 need not be installed in each hall of the elevator. Therefore, the function of the destination oriented allocation system (DOAS) is not impaired.

That is to say, due to the function of the destination floor indication control means, when a user boards the car from a hall, only the destination floor registered at that hall is indicated on the destination floor indication device 4. Therefore, the user can easily find his/her registered destination floor when boarding the car, and can immediately confirm that he/she has boarded the proper elevator car. Also, a peculiar problem at the time when a small-size liquid crystal display or the like is adopted as the indication section 5 of the destination floor indication device 4, that is, the conventional problem that the number of destination floors capable of being indicated is small so that a newly registered destination floor cannot be indicated can also be solved.

Incidentally, in this embodiment, there has been explained a case where the destination floor indication device 4 identifies the destination floor, which is registered from the hall at which the user boards the elevator car or aligning from the elevator car, by analyzing the registration information on the destination floor chronologically (S109 in FIG. 2). However, this is merely one example. There is no problem if the controller 3 accomplishes the identification. In this case, for example, when the user boards the elevator car or aligning from the elevator car at a hall, the controller 3 sends only the indication command of the destination floor, which is registered from that hall, to the destination floor indication device 4. According to this method, even if the destination floor of the user who has already boarded the car and the destination floor of the user who boards the car newly are the same, when the user who boards the car later boards the car, the destination floor of that user can be indicated on the destination floor indication device 4.

### Second Embodiment

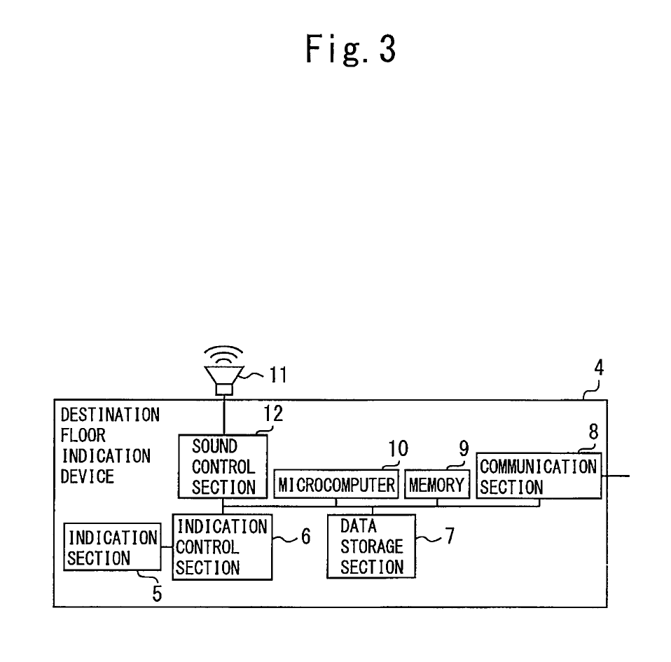

FIG. 3 is a block diagram showing the configuration of the essential portion of the elevator system in a second embodiment according to the present invention. In FIG. 3, reference numeral 11 denotes a sound generating section provided in the elevator car, and 12 denotes a sound control section provided in the destination floor indication device 4. The sound generating section 11 has a function of giving sound guidance to the user in the car, and is configured, for example, by a speaker or the like. The sound control section 12 has a function of controlling the sound output of the sound generating section 11.

Other components are the same as those in the first embodiment.

For the destination floor indication device 4 having the above-described configuration, for example, when the destination floor registered at that hall in S113 in FIG. 2 is indicated on the indication section 5, the sound generating section 11 provides sound guidance of the same content. That is, due to the function of the sound control section 12, when the user boards the car from a hall, only the destination floor registered at that hall is announced in the car.

According to the second embodiment of the present invention, the user boarding the car can more easily confirm that he/she has boarded the proper elevator car.

In the case where the controller 3 has a function of sending only the indication command of the destination floor registered from the hall, at which the user boards the elevator car and aligns from the elevator car, to the destination floor indication device 4, the sound control section 12 can be installed as a device separate from the destination floor indication device 4. In this case, when an indication command is sent to the destination floor indication device 4, the controller 3 sends a sound output command to the device provided with the sound control section 12.

In other respects, the second embodiment has the same configuration and effects as those of the first embodiment.

### INDUSTRIAL APPLICABILITY

The elevator system according to the present invention can be applied to a system in which a destination floor registration device is installed in a hall, and based on the destination floor registered by this destination floor registration device, a plurality of elevators are operation-controlled.

1. An elevator system comprising:
a destination floor registration device which is provided in an elevator hall so that a user registers a destination floor before boarding an elevator car;
a group controller for performing group control of a plurality of elevators based on the destination floor registered from the destination floor registration device;
a destination floor indication device provided in the car of the elevator to indicate the destination floor of the car; and
destination floor indication control section which causes the destination floor indication device to indicate only the destination floor registered from the hall when a user boards the car from the hall.

2. The elevator system according to claim 1, wherein during the time when the car of the elevator is running, the destination floor indication control section causes the destination floor indication device provided in the car to indicate all the destination floors of the car.

3. The elevator system according to claim 1, further comprising:
a controller which controls the operation of the elevator based on an operation command given from the group controller, and sends an indication command of the destination floor to the destination floor indication device according to the operation condition of the elevator, and
wherein
the destination floor indication control section identifies the destination floor registered from the hall based on a difference between the indication command received by the destination floor indication device when the user boards the car from the hall and the indication command received by the destination floor indication device during the time when the car is running just before the boarding.

4. The elevator system according to claim 1, further comprising:
a controller which controls the operation of the elevator based on an operation command given from the group controller, and sends an indication command of the destination floor to the destination floor indication device according to the operation condition of the elevator, and
wherein
the controller sends only the indication command of the destination floor which is registered from the hall to the destination floor indication device when a user boards the car from the hall.

5. The elevator system according to claim 1, comprising:
a sound generating section provided in the car of the elevator to give sound guidance to a user in the car; and
a sound control section which causes the sound generating section to be announced only the destination floor registered from the hall when a user boards the car from the hall.

6. The elevator system according to claim 2, further comprising:
a controller which controls the operation of the elevator based on an operation command given from the group controller, and sends an indication command of the destination floor to the destination floor indication device according to the operation condition of the elevator, and
wherein
the destination floor indication control section identifies the destination floor registered from the hall based on a difference between the indication command received by the destination floor indication device when the user boards the car from the hall and the indication command received by the destination floor indication device during the time when the car is running just before the boarding.

7. The elevator system according to claim 2, further comprising:
a controller which controls the operation of the elevator based on an operation command given from the group controller, and sends an indication command of the destination floor to the destination floor indication device according to the operation condition of the elevator, and
wherein
the controller sends only the indication command of the destination floor which is registered from the hall to the destination floor indication device when a user boards the car from the hall.

8. The elevator system according to claim 2, comprising:
a sound generating section provided in the car of the elevator to give sound guidance to a user in the car; and
a sound control section which causes the sound generating section to be announced only the destination floor registered from the hall when a user boards the car from the hall.
